(19) United States
(12) Patent Application Publication
(10) Pub. No.: US 2014/0198104 A1
(43) Pub. Date: Jul. 17, 2014

(54) STEREOSCOPIC IMAGE GENERATING METHOD, STEREOSCOPIC IMAGE GENERATING DEVICE, AND DISPLAY DEVICE HAVING SAME

(71) Applicant: Yuhji Tanaka, Osaka-shi (JP)

(72) Inventor: Yuhji Tanaka, Osaka-shi (JP)

(73) Assignee: SHARP KABUSHIKI KAISHA, Osaka-shi, Osaka (JP)

(21) Appl. No.: 14/238,531

(22) PCT Filed: Aug. 29, 2012
(86) PCT No.: PCT/JP2012/071796

§ 371 Date: Feb. 12, 2014

(30) Foreign Application Priority Data
Sep. 2, 2011 (JP) 2011-191561

(51) Int. Cl. G06T 15/50

(52) U.S. Cl. CPC G06T 15/50
USPC 345/426

(57) ABSTRACT

A luminance gradient calculating unit of a stereoscopic image generating device calculates luminance gradient indicating amount in change of luminance between a pixel of interest and an adjacent pixel, a right eye image generating unit corrects luminance of the pixel with that correction amount of the same sign as the luminance gradient such that the greater the absolute value of luminance gradient or the smaller the distance is the greater the luminance is. The left eye image generating unit performs correction of the luminance of the pixel with a correction amount of the opposite sign of the luminance gradient. This enables stereoscopy due to difference generated in luminance distribution between the left eye image and right eye image, and also the position of pixel is not changed and thus can be kept from appearing in double or not readily appearing in double.

### TECHNICAL FIELD

The present invention relates to a stereoscopic image generating method, and more particularly relates to a method for generating a stereoscopic image including a left eye image and a right eye image enabling stereoscopy, a generating device thereof, and a display device including the same.

### BACKGROUND ART

Many display devices which enable stereoscopy, such as 3D television devices, 3D game devices, and so forth, have come to be sold as of recent. A 3D television, for example, performs stereoscopic display based on video sources such as 3D movies or the like, that have been configured beforehand to enable stereoscopic display. A 3D game device performs stereoscopic display based on game images that have been generated beforehand to enable stereoscopic display. Further, computer devices capable of 3D display may generate stereoscopic images based on computer graphics techniques, and perform stereoscopic display of these images.

For example, Japanese Unexamined Patent Application Publication No. 2007-141156 discloses a technique of coordinate conversion from object coordinates to display coordinates for a right visual field image and left visual field image, based on a computer graphics 3D drawing technique, thereby generating stereoscopic image data in a binocular disparity format.

### CITATION LIST

### Patent Literature

PTL 1: Japanese Unexamined Patent Application Publication No. 2007-141156

### SUMMARY OF INVENTION

### Technical Problem

However, conventional techniques including the technique disclosed in Japanese Unexamined Patent Application Publication No. 2007-141156 generally involve horizontally shifting the positions of a subject included in a left eye image and right eye image, thereby generating disparity which enables stereoscopy. Accordingly, displaying such a left eye image and right eye image on a display device such as a 3D television device which alternately displays the left eye image and right eye image, which are then provided to the respective eye by an active shutter device which shields the view of one eye of the viewer who is a user, results in the image appearing double (shifted) to a view who is not using an active shutter device (not a user). This is generally the same with a technique where the left eye image and right eye image are displayed at the same time to obtain stereoscopy (e.g., cross-eyed method or the like), as well.

Further, the above-described conventional technique often causes even viewers using active shutter devices to see images in double (shifted). Of course, the image should not appear in double if ideal conversion from a planar image to a stereoscopic image is performed. However, enabling portions hidden in the planar image to be viewable in the stereoscopic image is all but impossible. Further, there is a phenomenon which often occurs in practice where the images shifted horizontally do not appear stereoscopic but simply appear double.

Accordingly, it is an object of the present invention to provide a stereoscopic image generating method and a stereoscopic image generating device in which display of a left eye image and right eye image do not appear in double or do not readily appear in double, and a display device having the same.

### Solution to Problem

A first aspect of the present invention is a stereoscopic image generating method to generate an image enabling stereoscopy, based on one or more input images representing a three-dimensional object, and distance to the three-dimensional object corresponding to pixels of the input image, the method including:

a luminance gradient calculating step to, when having set a starting point and ending point which determine a luminance gradient calculation direction corresponding to a direction from one eye to the other eye of a user who performs stereoscopy, such that the ending point is a pixel of interest included in the input image and the starting point is a pixel adjacent to or near the pixel of interest, calculate a luminance gradient from the pixel serving as the starting point to the pixel of interest;

a luminance-corrected image generating step to generate an image where the input image has been subjected one or two luminance corrections, by performing at least one of a first correction in which a correction amount of the same sign as that of the positive or negative luminance gradient is applied to the luminance of the pixel of interest, and a second correction in which a correction amount of the opposite sign as that of the positive or negative luminance gradient is applied to the luminance of the pixel of interest; and

a correction amount calculating step to set the correction amount such that the greater an absolute value of the luminance gradient is, and the smaller the distance corresponding to the pixel of interest is, the greater an absolute value of the correction amount is;

wherein, in the luminance-corrected image generating step, either the luminance-corrected image obtained by the first correction, or in a case where this image is not generated, the input image, is output as an image to be provided to the other eye of the user, and either the luminance-corrected image obtained by the second correction, or in a case where this image is not generated, the input image, is output as an image to be provided to the one eye of the user.

In a second aspect of the present invention according to the first aspect, in the correction amount calculating step, in a case where an absolute value of a derivative value, indicating a rate of change of distance corresponding to the pixel of interest in a predetermined direction, is equal to or greater than a predetermined threshold value, determination is made that the pixel of interest is included in an edge portion of the input image, and the correction amount is set to zero.

In a third aspect of the present invention according to the first aspect,

in the correction amount calculating step, the correction amount is determined such that the smaller a high-frequency component in change of corresponding distance in a predetermined direction is, the greater an absolute value of the correction amount of the pixel of interest is.

A fourth aspect of the present invention is a stereoscopic image generating device to generate an image enabling stereoscopy, based on one or more input images representing a three-dimensional object, and distance to the three-dimensional object corresponding to pixels of the input image, including:

a luminance gradient calculating unit configured to, when having set a starting point and ending point which determine a luminance gradient calculation direction corresponding to a direction from one eye to the other eye of a user who performs stereoscopy, such that the ending point is a pixel of interest included in the input image and the starting point is a pixel adjacent to or near the pixel of interest, calculate a luminance gradient from the pixel serving as the starting point to the pixel of interest;

a luminance-corrected image generating unit configured to generate an image where the input image has been subjected one or two luminance corrections, by performing at least one of a first correction in which a correction amount of the same sign as that of the positive or negative luminance gradient is applied to the luminance of the pixel of interest, and a second correction in which a correction amount of the opposite sign as that of the positive or negative luminance gradient is applied to the luminance of the pixel of interest; and a correction amount calculating unit configured to set the correction amount such that the greater an absolute value of the luminance gradient is, and the smaller the distance corresponding to the pixel of interest is, the greater an absolute value of the correction amount is;

wherein, the luminance-corrected image generating unit outputs either the luminance-corrected image obtained by the first correction, or in a case where this image is not generated, the input image, as an image to be provided to the other eye of the user, and outputs either the luminance-corrected image obtained by the second correction, or in a case where this image is not generated, the input image, as an image to be provided to the one eye of the user.

In a fifth aspect of the present invention according to the fourth aspect,

the luminance-corrected image generating unit generates one luminance-corrected image by performing only one of the first and second correction.

In a sixth aspect of the present invention according to the fourth aspect,

in a case where an absolute value of a derivative value, indicating a rate of change of distance corresponding to the pixel of interest in a predetermined direction, is equal to or greater than a predetermined threshold value, the correction amount calculating unit determines that the pixel of interest is included in an edge portion of the input image, and sets the correction amount to zero.

In a seventh aspect of the present invention according to the fourth aspect,

in a case where an absolute value of a derivative value, indicating a rate of change of distance corresponding to the pixel of interest in a predetermined direction, is equal to or greater than a predetermined threshold value, and the absolute value of the luminance gradient is equal to or greater than a predetermined threshold value, the correction amount calculating unit determines that the pixel of interest is included in an edge portion of the input image, and sets the correction amount to zero.

In an eighth aspect of the present invention according to the fourth aspect,

the correction amount calculating unit determines the correction amount such that the smaller a high-frequency component in change of corresponding distance in a predetermined direction is, the greater an absolute value of the correction amount of the pixel of interest is.

In a ninth aspect of the present invention according to the eighth aspect,

the correction amount calculating unit restricts the absolute value of the correction amount to a predetermined value or lower.

In a tenth aspect of the present invention according to the fourth aspect,

the input image is an image enabling stereoscopy, and is made up of a first input image to be provided to the other eye of the user, and a second input image to be provided to the one eye of the user;

wherein, in order to further strengthen the three-dimensional sensation obtained when performing stereoscopy of the input image, the luminance-corrected image generating unit outputs either the luminance-corrected image obtained by the first correction having been performed on the first input image, or in a case where this image is not generated, the first input image, as an image to be provided to the other eye of the user, and outputs either the luminance-corrected image obtained by the second correction having been performed on the second input image, or in a case where this image is not generated, the second input image, as an image to be provided to the one eye of the user.

In an eleventh aspect of the present invention according to the fourth aspect,

in order to weaken the three-dimensional sensation obtained when performing stereoscopy of the input image, the luminance-corrected image generating unit outputs either the luminance-corrected image obtained by the second correction having been performed on the first input image, or in a case where this image is not generated, the first input image, as an image to be provided to the other eye of the user, and outputs either the luminance-corrected image obtained by the first correction having been performed on the second input image, or in a case where this image is not generated, the second input image, as an image to be provided to the one eye of the user.

A twelfth aspect of the present invention is a stereoscopic image display device comprising: the stereoscopic image generating device according to the fourth aspect;

a display unit configured to alternately display an image to be provided to one eye of the user and an image to be provided to the other eye; and a shutter unit configured to, in a case where the image to be provided to the one eye is displayed on the display unit, perform shielding such that the image is not visible to the other eye of the user, and in a case where the image to be provided to the other eye is displayed, perform shielding such that the image is not visible to the one eye of the user.

### Advantageous Effects of Invention

According to the first aspect of the present invention, stereoscopic images can be generated from which suitable and sufficient three-dimensional sensation can be obtained in accordance with distance, with no more than simple computation to calculate luminance gradient between the pixel of interest and the starting point pixel. Only luminance correction is performed and positions of pixels are not changed, so even if output images (typically left eye images and right eye images) are displayed (for example, alternately), these can be kept from appearing in double or not readily appearing in double. Further, due to this, the contents of the image, displayed typically on a frame-sequential 3D display television or the like, can be easily recognized by those not wearing the active shutter device (viewers who are not users), thus avoiding an unpleasant experience for such viewers.

According to the second aspect of the present invention, in a case where the absolute value of a derivative value of distance is equal to or greater than the threshold value, determination is made that the pixel of interest is included in the edge portion, and the correction amount is set to zero, so change in luminance around the edge can be avoided from becoming abnormally great. Also, difference (in luminance) between the two output images (right eye image and left eye image) near edges can be suppressed or resolved. Accordingly, the user seeing the images in double when viewing the stereoscopic image can be prevented in a sure manner.

According to the third aspect of the present invention, if the distance of the pixel of interest is smaller than the distance of surrounding pixels, the value of high-frequency component of distance becomes small (typically becomes negative), so the absolute value of correction amount is set so as to be great. The three-dimensional sensation of (protruding images formed by) pixels at positions where distance is great and three-dimensional sensation is hard to obtain is emphasized, thereby obtaining an image where overall three-dimensional texture is clearly sensed.

According to the fourth aspect of the present invention, advantages the same as the first aspect of the present invention can be obtained in the stereoscopic image generating device.

According to the fifth aspect of the present invention, only one of the first and second correction is performed, so a stereoscopic image with sufficient three-dimensional sensation can be generated with calculation even easier than a case of performing both.

According to the sixth aspect of the present invention, in a case where the absolute value of a derivative value of distance is equal to or greater than the threshold value, the correction amount is set to zero, so change in luminance around the edge can be avoided from becoming abnormally great, in the same way as the advantages according to the second aspect. Also, seeing the images in double can be prevented in a sure manner.

According to the seventh aspect of the present invention, in a case where the absolute value of a derivative value of distance is equal to or greater than the threshold value, and moreover the absolute value of the luminance gradient is equal to or greater than a predetermined threshold value, the correction amount is set to zero, so change in luminance around the edge can be avoided from becoming abnormally great without erroneous detection occurring, and seeing the images in double can be prevented in a sure manner.

According to the eighth aspect of the present invention, the absolute value of the correction amount is set to be great when the value of the high-frequency component of distance becomes small, so an image where overall three-dimensional texture is clearly sensed can be obtained, in the same way as with the advantages of the third aspect of the present invention.

According to the ninth aspect of the present invention, the absolute value of the correction amount is restricted to a magnitude equal to or smaller than a predetermined value, so luminance correction (resulting in an output image) abnormality due to the absolute value of the correction amount can be prevented, and suitable luminance correction can be performed.

According to the tenth aspect of the present invention, a stereoscopic image can be generated with further enhanced three-dimensional sensation from the first and second input images (typically right eye image and left eye image), by simple computation. Also, the three-dimensional sensation can be strengthened by increasing the absolute value of the correction amount, so the degree to which the three-dimensional sensation is to be strengthened can be optionally set.

According to the eleventh aspect of the present invention, a stereoscopic image can be generated with further enhanced three-dimensional sensation or conversely with weakened three-dimensional sensation, from the first and second input images (typically right eye image and left eye image), by simple computation. Also, the three-dimensional sensation can be strengthened by increasing the absolute value of the correction amount, and the three-dimensional sensation can be weakened by decreasing the absolute value of the correction amount, so the degree to which the three-dimensional sensation is to be strengthened or weakened can be optionally set.

According to the twelfth aspect of the present invention, advantages the same as the fourth aspect of the present invention can be obtained with the stereoscopic image display device.

### BRIEF DESCRIPTION OF DRAWINGS

FIG. 1 is a block diagram illustrating a configuration of a stereoscopic image generating device according to a first embodiment of the present invention.

FIG. 2 is a diagram illustrating the relation between luminance and the position of a portion of pixels horizontally adjacent, of the pixels making up a planar image externally provided, in the embodiment.

FIG. 3 is a diagram illustrating the relation between position and luminance gradient at the pixels illustrated in FIG. 2.

FIG. 4 is a diagram illustrating the relation between the positions of the pixels illustrated in FIG. 2, and distance corresponding to pixels of interest indicated by distance signals, in the embodiment.

FIG. 5 is a diagram illustrating distances corresponding to pixels obtained by distance signals, in the embodiment.

FIG. 6 is a diagram illustrating the relation between luminance and the position of a pixel group corresponding to a right eye image obtained by correcting the luminance of the series of pixels of interest illustrated in FIG. 2.

FIG. 7 is a diagram illustrating the relation between luminance and the position of a pixel group corresponding to a left eye image obtained by correcting the luminance of the series of pixels of interest illustrated in FIG. 2.

FIG. 8 is a block diagram illustrating a configuration of a stereoscopic image generating device according to a second embodiment of the present invention.

FIG. 9 is a diagram illustrating the relation between the positions of the series of pixels of interest illustrated in FIG. 2, and the high-frequency component of the distance of the pixels of interest, in a third embodiment of the present invention.

FIG. 10 is a diagram illustrating the relation between luminance and the position of a pixel group corresponding to a right eye image obtained by correcting the luminance of the series of pixels of interest illustrated in FIG. 2, in a case where stopping operation based on edge detection is not performed in a fourth embodiment of the present invention.

FIG. 11 is a diagram illustrating the relation between luminance and the position of a pixel group corresponding to a left eye image obtained by luminance correction in the embodiment.

FIG. 12 is a block diagram illustrating a configuration of a stereoscopic image generating device according to a fifth embodiment of the present invention.

### DESCRIPTION OF EMBODIMENTS

Embodiments of the present invention will be described below with reference to the attached drawings.

### 1. First Embodiment

### <1.1 Overall Configuration and Operation>

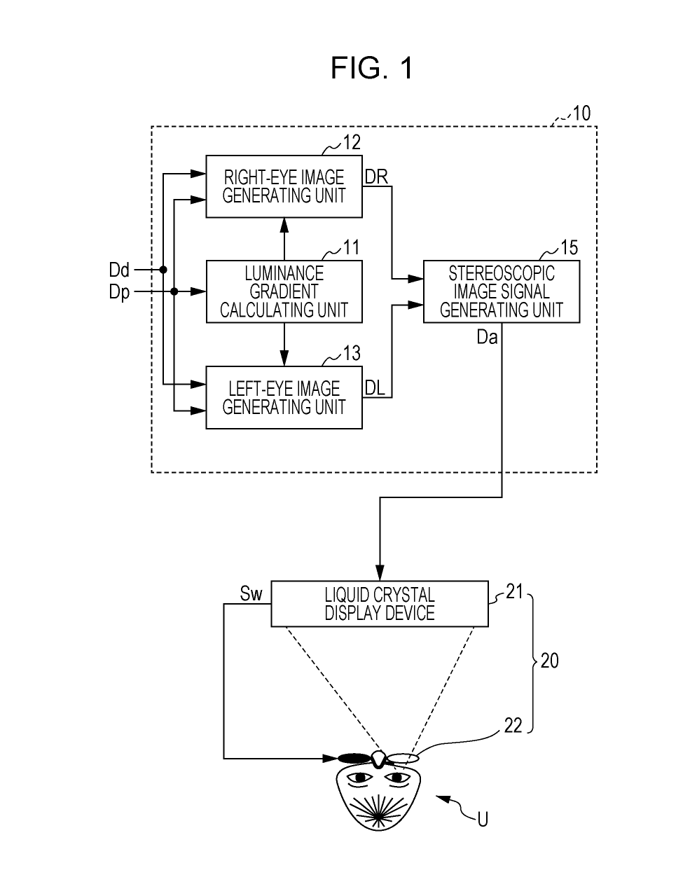

FIG. 1 is a block diagram illustrating the configuration of a stereoscopic image generating device according to a first embodiment of the present invention. As illustrated in FIG. 1, this stereoscopic image generating device 10 includes a luminance gradient calculating unit 11 which receives a video signal Dp including an external planar image (two-dimensional image) and a distance signal Dd indicating distance corresponding to a pixel in the planar image and calculates luminance gradient between adjacent pixels in the planar image, a right eye image generating unit 12 which generates a right eye image DR based on the planar image and luminance gradient, a left eye image generating unit 13 which generates a left eye image DL, and a stereoscopic image signal generating unit 15 which generates stereoscopic image signals Da from the right eye image DR and left eye image DL. Note that temporal change of an image is unrelated to generating of a stereoscopic image in the present invention, as will be described later, so while the video signals Dp are of moving images which change in increments of frame periods, this may be a still image instead. The stereoscopic image signals Da generated by the stereoscopic image signal generating unit 15 are provided to a 3D display device 20.

Note that the stereoscopic image generating device 10 will be described as a device different from the 3D display device 20, but the stereoscopic image generating device 10 may be built into the 3D display device 20. Also, the stereoscopic image generating device 10 assumes an unshown 3D graphics device, which generates distance corresponding to pixels along with a planar image. Such a 3D display device 20 and 3D graphics device are typically included in game devices, personal computers, and so forth. The unshown 3D graphics device which provides the stereoscopic image generating device 10 with video signals Dp and distance signal Dd specifically uses a known computer graphics technique to generate video signals Dp indicating a planar image obtained by viewing a three-dimensional object virtually situated in a three-dimensional space from a (virtual) viewpoint. The unshown 3D graphics device also generates distance signals Dd indicating distance corresponding to the pixels calculated based on the distance from the viewpoint to the three-dimensional object. The video signals Dp and distance signal Dd are generated based on information regarding the object, such as position color, material, and so forth, viewpoint coordinates, and information regarding the light source, such as position, color, and so forth, which are preset or externally provided. Now, while distance signals Dd are not transmitted along with the video signal Dp in current television broadcasting, but in a case where the distance signal Dd are to be broadcast, this stereoscopic image generating device 10 can be built into a television receiver and used. Thus, the distance corresponding to pixels is distance through the pixels of the planar image to each portion of the three-dimensional object represented by the planar image, typically from the viewpoint here, correlated to the pixels.

The 3D display device 20 includes a liquid crystal display device 21 which alternately displays the right eye image DR and left eye image DL a predetermined time (typically ½ frame period) based on the stereoscopic image signals Da. The 3D display device 20 also includes an eyeglass-type active shutter device 22 which shields the right eye or left eye of a user (viewer) U with that the corresponding eyes of the user U are alternately provided with the right eye image DR and left eye image DL. FIG. 1 illustrates an example where the liquid crystal display device 21 is displaying the right eye image DR, and the active shutter device 22 is shielding the visual field of the left eye of the user U, so that the right eye image DR is provided to the right eye of the user. The configuration of this 3D display device using such an active shutter device is known, so detailed description will be omitted.

Any known stereoscopic display format, such as for example, the lenticular lens format, parallax barrier format, or the like, may be used instead of the above-described format using the active shutter device (also called the frame sequential format), as long as the display device is capable of stereoscopic display. In the case of employing such formats, the right eye image DR and left eye image DL are displayed at the same time. The configuration and operations of the stereoscopic image signal generating unit 15 will be described below.

The luminance gradient calculating unit 11 in FIG. 1 calculates luminance gradient between adjacent or close pixels making up (one frame worth of) planar image (two-dimensional image) included in the externally-received video signals Dp. That is to say, the luminance gradient calculating unit 11 calculates how much the luminance of a certain pixel (hereinafter referred to as “pixel of interest”) has changed from the luminance of a pixel adjacent to the left (in this case) of that pixel (hereinafter referred to as “left pixel”). Note that while strictly speaking, luminance gradient is a derivative value of a so-called luminance function, illustrating the amount of change of luminance as to distance between pixels, we will hereinafter use this to mean a value indicating the rate of change of luminance between two horizontally adjacent pixels of which the distance is 1. Also, the direction from left to right will be referred to as luminance gradient calculating direction. Note that the derivative value of distance (gradient value) can also be calculated with a similar method.

Specifically, the luminance gradient calculating unit 11 includes a left pixel luminance storage unit which stores one pixel worth of (luminance value of) externally-received video signals Dp. The luminance gradient calculating unit 11 calculates a value obtained by subtracting the luminance value stored in the left pixel luminance storage unit from the luminance value of the received pixel of interest, as the luminance gradient. Note that strictly speaking, this value is a proportionate value of the luminance gradient which is a derivative value of a luminance function, and accordingly has to be further divided by the actual distance between the left pixel and the pixel of interest. However, as described above, we will say that the distance between the two adjacent pixels here is 1, and the value will be described as the luminance gradient. Note that in actual calculation, the distance between the two pixels does not have to be 1, which will be described later.

The right eye image generating unit 12 performs luminance correction where the luminance of the pixel of interest is increased in a case where the luminance gradient received from the luminance gradient calculating unit 11 is a positive value, and performs luminance correction where the luminance of the pixel of interest is decreased in a case where the received luminance gradient is a negative value. This is then output as (a pixel value of) the right eye image DR. The amount of increase and amount of decrease of luminance preferably changes so that the greater the absolute value of the luminance gradient is, the greater the absolute value thereof is. The reason is that a natural three-dimensional sensation is obtained, which will be described later. Also, the luminance gradient preferably changes so that the closer the distance of the pixel of interest is, the greater the absolute value thereof is. The reason is that the closer the distance is, the greater the three-dimensional sensation is.

First, if we say that the luminance value of the pixel of interest before correction at the right eye image generating unit 12 is DRp1, the luminance value following luminance correction is DR1, the distance value indicating the distance of the pixel of interest included in the distance signal Dd is Dd1, and a constant is c (c>0), the luminance value DR1 after luminance correction in accordance with the luminance gradient LG can be obtained by the following Expression (1).

DR1=DRp1×(1+LG×c/Dd1) (1)

Note that the above Expression (1) is only an example, and that the luminance value DR1 of the pixel of interest following luminance correction may be calculated from other predetermined mathematical expressions or based on a table defining correlations of values. In this configuration, the increase in amount correlates to the amount of correction when the luminance gradient is a positive value, and the decrease in amount correlates to the amount of correction when the luminance gradient is a negative value.

Also, if we say that the luminance value of the pixel of interest before correction at the left eye image generating unit 13 is DLp1 and the luminance value following luminance correction is DL1, the luminance value DL1 after luminance correction in accordance with the luminance gradient LG can be obtained by the following Expression (2).

DL1=DLp1×(1−LG×c/Dd1) (2)

Note that the above Expression (2) is also only an example, and that the luminance value DL1 of the pixel of interest following luminance correction may be calculated from other predetermined mathematical expressions or based on a table defining correlations of values, in the same way as with the Expression (1). For example, instead of multiplying the luminance gradient LG by the inverse of the distance value Dd1 as with the above Expression (1) or the above Expression (2), the luminance gradient LG may be multiplied by a value defined as a function of the distance value Dd1.

Thus, in a case where the luminance gradient received from the luminance gradient calculating unit 11 is a positive value, the left eye image generating unit 13 performs luminance correction to reduce the luminance of the pixel of interest, and in a case where the luminance gradient is a negative value, to increase the luminance of the pixel of interest. The left eye image generating unit 13 then outputs this as (the pixel value of) the left eye image DL. We will say here that the absolute value of the amount of increase and amount of decrease of this luminance (correction amount) is the same value as the absolute value of the amount of increase and amount of decrease of this luminance (correction amount) at the right eye image generating unit 12, for the sake of facilitating description.

That is to say, in a case where correction is performed to increase the luminance at the right eye image generating unit 12, correction is performed at the left eye image generating unit 13 to reduce luminesce, as described above. However, the absolute value of the amount of increase (correction amount at the right eye image generating unit 12) and the absolute value of the amount of decrease (correction amount at the left eye image generating unit 13) are not in unique correlation with the disparity amount (shift amount) to the right direction and the disparity amount (shift amount) to the left direction. Accordingly, the correction amount is preferably obtained from a predetermined calculation or empirical rule, but we will say here that (the absolute values are) the same, for the sake of facilitating description. In this way, the left eye image generating unit 13 performs luminance correction with opposite increase and decrease as to the luminance correction operations of the right eye image generating unit 12.

The stereoscopic image signal generating unit 15 generates stereoscopic image signals Da alternatingly including the right eye image DR output from the right eye image generating unit 12 and the left eye image DL output from the left eye image generating unit 13 in predetermined time (typically, ½ frame period) increments. The stereoscopic image signals Da are played on the 3D display device 20 as described earlier, and recognized as three-dimensional images by the user U (viewed stereoscopically).

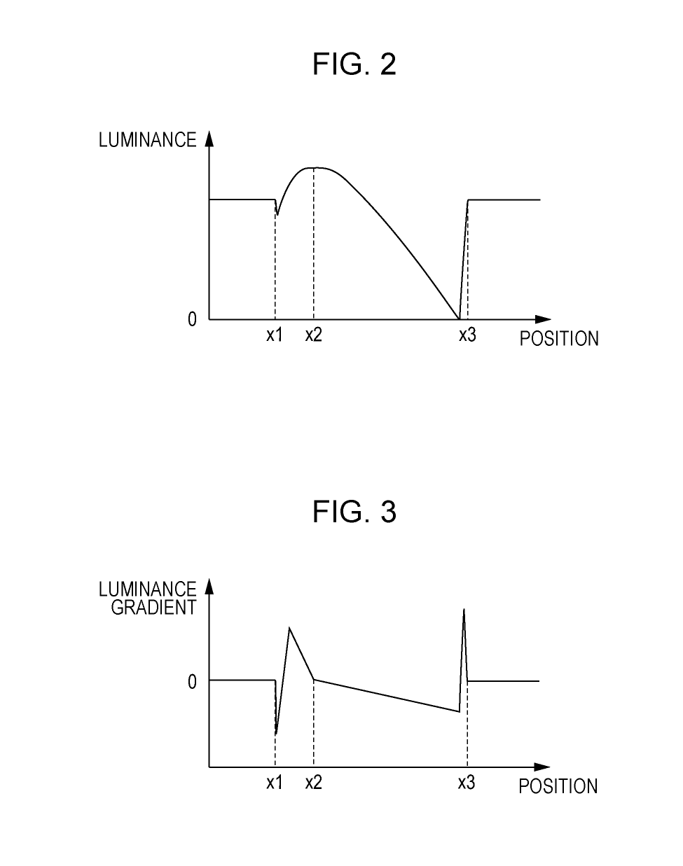

Note that the functions of the stereoscopic image generating device 10 such as described above, are realized by hardware including predetermined logic circuits corresponding to each of the above components. However, part of all of the functions may be realized by installing an operating system and predetermined application software and the like in a general personal computer having a CPU (Central Processing Unit), semiconductor memory, and a storage unit such as a hard disk, so as to realize the functions corresponding to the components by software. Next, the above-described luminance correction operations of the stereoscopic image generating device 10 will be described in detail with reference to FIG. 2 through FIG. 7.

### <1.2 Luminance Correction Operations of Stereoscopic Image Generating Device>

FIG. 2 is a diagram illustrating the relation between luminance and the position of a portion of pixels horizontally adjacent, of the pixels making up a planar image externally provided. Also, FIG. 3 is a diagram illustrating the relation between position and luminance gradient at the pixels illustrated in FIG. 2. Note that hereinafter, pixels illustrated in these drawings will be referred to as a “series of pixels of interest”, where the pixels included in the series of pixels of interest are horizontally adjacent so the Y-coordinates thereof are the same, and the X-coordinates match the pixel positions illustrated in the drawings.

As illustrated in FIG. 2 and FIG. 3, the luminance of pixels in the series of pixels of interest is contestant up to position x1 (the luminance gradient is 0). Thereafter, the luminance of pixels rapidly drops from position x1 and then immediately rises. At position x2, the luminance of the pixels turns from rising to falling (after having become constant). That is to say, the luminance gradient passes through 0 to change from a positive value to a negative value. Thereafter, following the luminance of the pixels having continued to drop, the luminance of the pixels rapidly rises, and is constant from position x3 (the luminance gradient is 0).

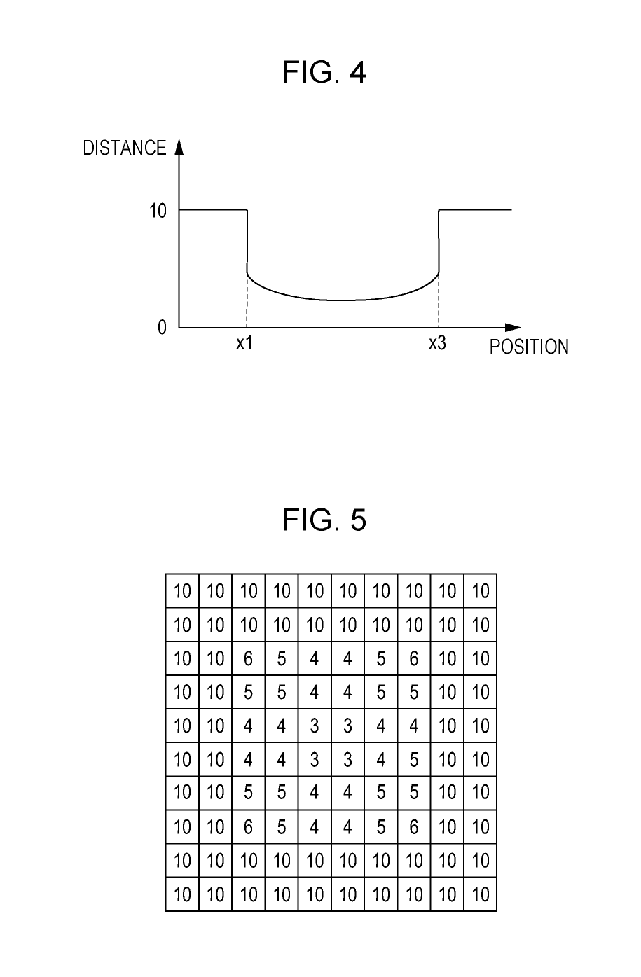

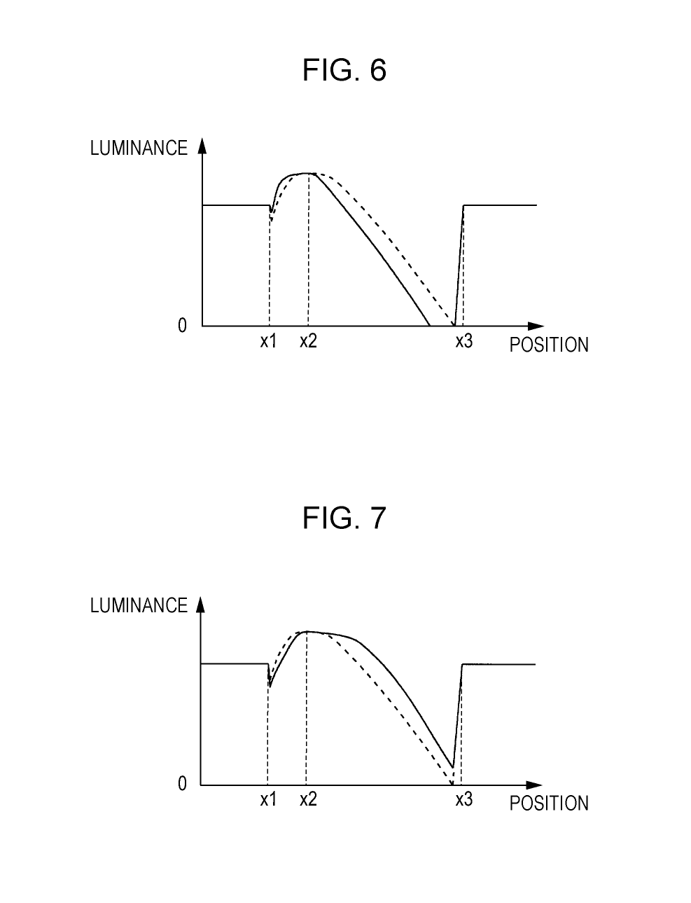

The luminance gradient calculating unit 11 selects a pixel of interest one at a time from the series of pixels of interest, by changing the x coordinate one at a time from left to right, and calculates the luminance gradient of the selected pixel of interest. The calculated luminance gradient and distance signal Dd are provided to the right eye image generating unit 12 and left eye image generating unit 13 as described above, and the luminance of the pixel of interest is corrected based on the Expression (1) and the Expression (2). Specifically, the luminance of the series of pixels of interest in FIG. 2 and FIG. 3 is corrected as illustrated in FIG. 6 and FIG. 7, with reference to the distances corresponding to the pixels of interest illustrated in FIG. 4 and FIG. 5.

FIG. 4 is a diagram illustrating the relation between the positions of the series of pixels of interest illustrated in FIG. 2 and distance to the pixels of interest indicated by distance signals, and FIG. 5 is a diagram illustrating distances corresponding to pixels obtained by the distance signals. As illustrated in FIG. 5, the distance signals Dd include distance corresponding to the pixels, but distance is not determined for each pixel. Rather, one distance corresponding to one pixel block made up of multiple nearby pixels is determined. Of course, distance may be determined for each pixel. The distance of each pixel is calculated by known interpolation computation, based on the distance values of the blocks illustrated in FIG. 5, and the positions of each pixel in their block.

FIG. 4 illustrates, of the distances illustrated in FIG. 5, change in distance corresponding to a series of pixels of interest. At position x1, the distance of the series of pixels of interest greatly changes (comes closer to the viewpoint position) then gradually changes, and at position x3 greatly changes again (draws away from the viewpoint position). An example of such an image is an image where a wall situated in parallel to the screen at a distance of 10 serves as the background of the entire screen, and further a sphere is floating at the middle of the screen at a distance of around 5.

FIG. 6 is a diagram illustrating the relation between luminance and the position of a pixel group corresponding to a right eye image obtained by correcting the luminance of the series of pixels of interest illustrated in FIG. 2. The dotted line in the drawing represents the series of pixels of interest illustrated in FIG. 2. Comparing FIG. 6 with FIG. 2 shows that the luminance of the pixels of interest is uncorrected up to the position x1 where the luminance does not change (the luminance gradient is 0). Thereafter, the luminance of the pixels of interest up to the position x2 where luminance increases has been corrected so as to increase, and the luminance of the pixels of interest from the position x2 where luminance decreases has been corrected so as to decrease. Also, the luminance of the pixels of interest is uncorrected from the position x3 where the luminance does not change (the luminance gradient is 0).

FIG. 7 is a diagram illustrating the relation between luminance and the position of a pixel group corresponding to a left eye image obtained by correcting the luminance of the series of pixels of interest illustrated in FIG. 2. The dotted line in the drawing represents the series of pixels of interest illustrated in FIG. 2. Comparing FIG. 7 with FIG. 2 shows that the luminance of the pixels of interest is uncorrected up to the position x1 where the luminance does not change (the luminance gradient is 0). Thereafter, the luminance of the pixels of interest up to the position x2 where luminance increases has been corrected so as to decrease, and the luminance of the pixels of interest from the position x2 where luminance decreases has been corrected so as to increase. Also, the luminance of the pixels of interest is uncorrected from the position x3 where the luminance does not change (the luminance gradient is 0).

Note that the luminance values of the pixels of interest after correction, illustrated in FIG. 6 and FIG. 7, have been subjected to so-called clipping correction or luminance value calculation of a form equivalent to clipping correction, so that the value does not exceed a predetermined maximum value or fall below a predetermined minimum value. Moreover, correction is not performed in cases where the absolute value of luminance gradient exceeds a predetermined edge detection threshold value. Description of such luminance correction operations will be omitted here for the sake of facilitating description, and will be described in other embodiments and modifications.

As described above, the distribution of luminance of the series of pixels of interest included in the right eye image DR after correction, as illustrated in FIG. 6, has changed so as to be shifted overall toward the left side as compared to the luminance of the series of pixels of interest before correction as illustrated in FIG. 2. Also, the distribution of luminance of the series of pixels of interest included in the left eye image DL after correction, as illustrated in FIG. 7, has changed so as to be shifted overall toward the right side as compared to the luminance of the series of pixels of interest before correction as illustrated in FIG. 2. Thus, even though the positions of pixels corresponding to the right eye image DR and left eye image DL have not changed, the overall luminance distribution of the pixels has changed, which generates disparity or difference equivalent to disparity at both eyes of the user U, thereby realizing stereoscopy. Also, the positions of pixels corresponding to the right eye image DR and left eye image DL do not change, and accordingly do not appear double or do not readily appear double (even though there is difference in luminance distribution) by being displayed (in a short time) on the liquid crystal display device 21, or to those not wearing the active shutter device 22.

Also, since the configuration according to the present embodiment does not generate disparity by changing the horizontal positions of the pixels as with conventional configurations, the right eye image DR and left eye image DL do not appear double or do not readily appear double (even though there is difference in luminance distribution) to those wearing the active shutter device 22 as well.

Now, while generating disparity (or difference equivalent thereto) in distribution of luminance between the right eye image DR and left eye image DL as described above enables stereoscopy, a configuration, where the right eye image DR and left eye image DL are generated simply by moving the luminesce distribution in a planar image by to the left and right directions by a predetermined amount each, cannot be said to be sufficient in all cases. It is thought that the reason why sufficient three-dimensional sensation is not obtained with this configuration is related to the fact that the three-dimensional sensation of objects sensed based on difference in distribution of luminance is particularly strong regarding convex curved faces having roundness, such as spherical faces. For example, if light from (a light source at) the left side, typically from the upper left direction, is cast on a half-sphere convex curved face, a portion where light is particularly strongly reflected (specifically, specular reflection and diffused reflection), i.e., a high-luminance portion, is generally generated at the upper left of the curved plane. When the curved plane including this high-luminance portion is viewed from the left and right eyes, not only is the position of the high-luminance portion (luminance distribution) shifted in the left and right directions, but also the high-luminance portion looks wider from the left eye, and the high-luminance portion looks narrower from the right eye. Also, the smaller the distance from the viewpoint is, the greater the shift in this luminance distribution is, and also the wider the high-luminance portion is as viewed from the left eye. The stereoscopic image generating device 10 can (virtually) realize the state of luminance distribution when viewing a curved plane under such a (virtual) illumination environment by simple computation, so a strong three-dimensional sensation sensed on a rounded convex curved plane can be obtained.

While the above description has been made focusing on high-luminosity portions and the distribution thereof, description can also be made focusing on low-luminosity portions and the distribution thereof. That is to say, three-dimensional sensation of objects can be obtained from shadows generated by light being shielded by the object (called “Cast Shadow”) and shading generated by how light is cast on the surface of an object (called “Attached Shadow”). Accordingly, a three-dimensional sensation can be obtained using the above shading (Attached Shadow). This changes in accordance to the position of the light source, and specifically three-dimensional sensation is obtained due to difference occurring in the angle between the left eye and the light source, and the angle between the right eye and the light source.

However, with the present invention, the position of the light source is fixed, that is to say the angle between the left eye and the light source and the angle between the right eye and the light source are made to be the same. Accordingly, the shading (Attached Shadow) itself is the same, but the luminance distribution of the low-luminance portion, which corresponds to shadows, is changed by changing the luminance distribution as described above. Describing this with an example following the example above, if light from (a light source at) the left side, typically from the upper left direction, is cast on a half-sphere convex curved face, a portion where light is does not readily reach, i.e., a low-luminance portion, is generally generated at the lower right of the curved plane. When the curved plane including this low-luminance portion is viewed from the left and right eyes, not only is the position of the low-luminance portion (luminance distribution) shifted in the left and right directions, but also the low-luminance portion looks narrower from the left eye, and the low-luminance portion looks wider from the right eye. Also, the smaller the distance from the viewpoint is, the greater the shift in this luminance distribution is, and also the wider the low-luminance portion is as viewed from the right eye. The stereoscopic image generating device 10 can (virtually) realize the state of luminance distribution such as described above by simple computation, so a strong three-dimensional sensation sensed on a rounded convex curved plane can be obtained.

Also, in the configuration according to the present embodiment, the part of the high-luminance portion around the peak luminance is the part where the sign of luminance gradient changes from plus to minus, i.e., is the part around where the luminance gradient is 0, so the luminance of this part is not corrected or correction is very small. Thus, this peak luminance part is not shifted horizontally, so it can be said that the image does not readily appear in double to those wearing the active shutter device 22, from this perspective as well.

### <1.3 Advantages of First Embodiment>

As described above, the stereoscopic image generating device 10 according to the present embodiment can generate stereoscopic images from which suitable and natural (and sufficient) three-dimensional sensation can be obtained in accordance with distance from a single planar image, with no more than simple computation to calculate luminance gradient between adjacent pixels. The positions of pixels are not changed, so even if left eye images and right eye images are displayed (typically alternately), these can be kept from appearing in double or not readily appearing in double. Further, due to this, the contents of the image, displayed typically on a frame-sequential 3D display device or the like, can be easily recognized by those not wearing the active shutter device 22 (viewers who are not users), thus avoiding an unpleasant experience for such viewers.

### <1.4 First Modification of First Embodiment>

The luminance gradient calculating unit 11 according to the present embodiment calculates luminance gradient indicating the rate of change in luminesce in the direction from a left pixel toward the pixel of interest, i.e., in the luminance gradient calculating direction, but the direction from a right pixel to the pixel of interest may be used as the luminance gradient calculating direction to calculate luminance gradient indicating the rate of change thereof. This configuration will include a right pixel luminance storage unit which stores one pixel worth of (luminance value of) externally-received video signals Dp.

Also, the luminance gradient calculating direction in this configuration is opposite to that in the case of the first embodiment, so the right eye image generating unit 12 and the left eye image generating unit 13 are exchanged in the configuration. That is to say, the right eye image generating unit 12 performs luminance correction where the luminance of the pixel of interest is decreased in a case where the luminance gradient is a positive value, and performs luminance correction where the luminance of the pixel of interest is increased in a case where the received luminance gradient is a negative value. This is then output as (a pixel value of) the right eye image DR. Conversely, the left eye image generating unit 13 performs luminance correction where the luminance of the pixel of interest is increased in a case where the luminance gradient is a positive value, and performs luminance correction where the luminance of the pixel of interest is decreased in a case where the received luminance gradient is a negative value. This is then output as (a pixel value of) the left eye image DL. Thus, when the above-described curved plane is viewed the high-luminance portion looks narrower from the left eye, and the high-luminance portion looks wider from the right eye. Accordingly, a three-dimensional sensation is obtained as with a case where the light source is actually to the upper right, which is opposite to the case of the first embodiment.

Note that the degree of three-dimensional sensation obtained by this modification is exactly the same as the degree of three-dimensional sensation obtained by the configuration according to the first embodiment. However, the illumination light source is often situated to the upper left in general photographed images, so the configuration according to the first embodiment might be said to be more likely to match the actual illumination light source in the original planar image, which can be said to be more preferable than the configuration of the above-described modification with regard to this point. Also, a configuration may be conceived where the configuration of the first embodiment and the configuration of the modification are switched based on image contents, user operation input, and so forth, thereby enabling switching between a case where the position of a (virtual) illumination light source is at the upper left and a case of at the upper right. Further, a configuration may be made where light source information provided to an unshown 3D graphics device is received, and switching is performed based on this information.

### <1.5 Second Modification of First Embodiment>

The right eye image generating unit 12 according to the present embodiment performs luminance correction based on the above Expression (1) and the left eye image generating unit 13 performs luminance correction based on the above Expression (2). However, a configuration may be made where these luminance corrections are made restrictively in accordance with distance of luminance value.

For example, a configuration may be made where the above-described luminance correction is performed only in cases where the distance value Dd1 is smaller than a predetermined threshold value, and luminance correction is not performed if equal to or greater than a predetermined threshold value. That is to say, this configuration does not perform the above-described luminance correction for images displayed by pixels corresponding to a distance which is a certain level (the above threshold) or farther, since three-dimensional sensation is not readily sensed.

Accordingly, computation relating to the luminance correction can be omitted, and further, positions of pixels are not changed, so even if left eye images and right eye images are displayed (typically alternately), these can be kept from appearing in double or not readily appearing in double.

Also, a configuration may be made where the above-described luminance correction is performed only in cases where the absolute value of luminance is smaller than a predetermined threshold value, and luminance correction is not performed if equal to or greater than a predetermined threshold value. That is to say, the luminance value DR1 obtained by the Expression (1) may exceed a displayable value if the sign of the luminance gradient is plus and the value of the luminance gradient is extremely great. Even if a displayable value is not exceeded, the correction amount (amount of increase) may be too great. On the other hand, the luminance value DR1 may fall below a displayable value if the sign of the luminance gradient is minus and the value of the luminance gradient is extremely small (i.e., in a case where the absolute value of the luminance gradient is extremely great, the same as above). Even if a displayable value is not exceeded, the correction amount (amount of decrease) may be too great. Accordingly, a minimum value Min and maximum value Max are determined, and in a case where the luminance value DR1 is smaller than the minimum value Min, the value of the luminance value DR1 is set to the minimum value Min. In a case where the luminance value DR1 exceeds the maximum value Max, the value of the luminance value DR1 is set to the maximum value Max. Subjecting the luminance value DR1 to this sort of correction (hereinafter, this correction will be referred to as “clipping correction”) keeps the luminance value DR1 from exceeding the maximum value Max or falling below the minimum value Min. Thus, suitable luminance correction can be performed in the end. This holds true for the luminance value DL1 as well.

### <1.6 Third Modification of First Embodiment>

The above-described embodiment is a configuration which calculates luminance gradient based on a left pixel and a pixel of interest. This third modification is unlike the case of the first embodiment, in that a value equivalent to an average value of three luminance gradients between three pixels including pixels above and below a pixel of interest (hereinafter referred to as “pixel group of interest”) and three pixels to the left thereof, serving as starting points to calculate luminance gradient heading toward the above pixels (hereinafter referred to as “start pixel group”).

Note that the pixel group of interest may be two pixels including one or the other of pixels above and below a pixel of interest, or may be multiple pixels adjacent or near (above and below here) to the pixel of interest. In the same way, it is sufficient that the start pixel group be multiple pixels adjacent or near (above and below here).

Also, the actual video signals include luminance values for red (R), green (G), and blue (B), and the pixels P are made up of three sub-pixels to display each of the colors of RGB. However, for the sake of facilitating description, these colors will not be taken into consideration, and we will say that the luminesce values here are averages of the three color values or luminance values of grayscale display. Note that the average value of luminance of RGB is equal to brightness, so the same advantages can be obtained with the same configuration, even if the luminance value in the Present Description is replaced with brightness values in color pixels made up of three sub-pixels. Accordingly, a configuration may be made where brightness correction is performed in increments of color pixels, rather than performing luminance correction in sub-pixel increments. For example, a configuration where each luminance of RGB is suitable corrected in a correlated manner such that the greater the correction amount of brightness is, the closer the color approaches white, or the like. Such a correcting form can be considered to be the same as luminance correction in increments of color pixels.

Obtaining luminance gradient LG in this way yields a value equivalent to an average value of luminance gradients between a pixel group of interest and three pixels to the left thereof serving as a start pixel group, so the configuration is less likely to be influenced by noise (when transmitting, calculating, and so forth), as compared to the configuration of the first embodiment. That is to say, in a case where the pixel of interest or the pixel to the left thereof exhibits an abnormal luminance value which is different to its original value, due to the effect of noise, the luminance gradient thereof will also exhibit an abnormal value, influencing the image following luminance correction as well. However, the probability that pixels above and below, and pixels to the left thereof, have all been influenced by noise in the same way is small, so the influence of noise can be reduced by obtaining a value equivalent to the average value.

Also, in a case where an abnormality occurs during transmission of the image data or the above calculation, abnormalities often occur in one row of data of the pixel data or in the computation thereof. Accordingly, the influence of noise can be reduced by referencing data of difference (above and below) rows, i.e., using a value equivalent to the above average value. Thus, abnormality in a stereoscopic image which might occur due to abnormal luminance correction operations can be reduced.

Note that values obtained by known computation which reduces the influence of noise, such as weighted average value where pixel of interest is weighted with a great value, or representative values, or the like, may be used. Also, the luminance gradient calculating direction may be set to the opposite direction, in the same way as with the first modification. That is to say, the luminance gradient calculating unit 11 may calculate a luminance gradient equivalent to the average value of the range of change from a right pixel and pixels above and below, to a pixel of interest and pixels above and below. Also, as described above, a configuration may be may where switching is enabled between a case where the position of a (virtual) illumination light source is at the upper left and a case of at the upper right.

### <1.7 Fourth Modification of First Embodiment>

The above-described embodiment is a configuration where video signals Dp and distance signals Dd are provided to the stereoscopic image generating device 10 from an unshown 3D graphics device. However, a configuration may be made where one camera and a distance measuring device are provided instead of the 3D graphics device. The one camera is a known video shooting camera which outputs video signals Dp, and the distance measuring device is a known device which can measure distance to the object of shooting, such as a laser distance measuring device, for example.

Also, there is known a technique where distance for each pixel can be measured by analyzing images acquired by two cameras. Accordingly, the distance measuring device may comprise another camera and a device which analyzes image of another camera and two cameras. That is to say, a configuration may be made including, instead of the 3D graphics device, two cameras, and an image analyzing device which can typically calculate distance for each pixel, based on images shot by these cameras.

### 2. Second Embodiment

### <2.1 Overall Configuration and Operation>

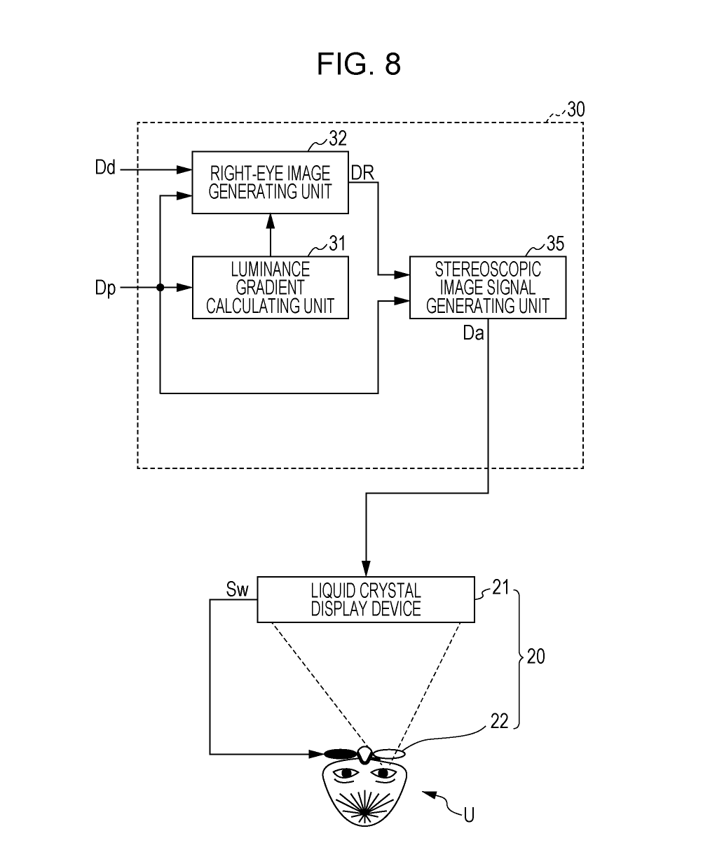

FIG. 8 is a block diagram illustrating the configuration of a stereoscopic image generating device according to a second embodiment of the present invention. As illustrated in FIG. 8, this stereoscopic image generating device 30 includes a luminance gradient calculating unit 31 which receives a video signals Dp and distance signals Dd externally (from an unshown D graphics device here) and calculates luminance gradient, performing operations the same as with the luminance gradient calculating unit 11 according to the first embodiment, a right eye image generating unit 32 which generates a right eye image DR based on the planar image indicated by the video signal Dp, distance at each pixel indicated by the distance signal Dd, and luminance gradient, which performs operations the same as with the right eye image generating unit 12 according to the first embodiment and a stereoscopic image signal generating unit 35 which generates stereoscopic image signals Da from the right eye image DR and the stereoscopic image signals Da from the planar image. The left eye image generating unit 13 which generates the left eye image DL in the first embodiment is omitted. Note that the 3D display device 20 in FIG. 8 is the same as with the first embodiment illustrated in FIG. 1, and accordingly will be omitted from description.

### <2.2 Luminance Correction Operation of Stereoscopic Image Generating Device>

As described above, the left eye image DL is not generated in the present invention, and the original planar image is used instead. While this configuration provides the original planar image to the left eye, the right eye image generating unit 32 performs luminance correction is that the right eye image DR provided to the right eye has a luminance distribution where high-luminance portions included in the planar image are narrower and shifted to the right side. Accordingly, a three-dimensional sensation like that of the case of the first embodiment can be obtained.

The first embodiment performs luminance correction of the planar image equally in the horizontal direction, so the amount of correction in the horizontal direction is greater than with the present embodiment (typically, twice). Accordingly, the amount of correction of the right eye image generating unit 32 in the present embodiment needs to be greater (typically, twice) in order to perform luminance correction which obtains the same sensation of distance (amount of disparity) as with the case of the first embodiment.

The greater the absolute value of the correction amount is, the greater the obtained three-dimensional sensation (closer sensation of distance) obtained is, with regard to this point. On the other hand, departure from the original planar image is also great (the luminance distribution is more greatly shifted), so there is a greater chance of the viewer sensing this to be unnatural. In light of this point, it can be said that the configuration of the first embodiment is more preferable. However, the configuration according to the second embodiment is simpler than configuration according to the first embodiment, which is desirable in that manufacturing costs of the device can be reduced, and also the amount of computation can be reduced.

While the left eye image generating unit 13 is omitted in the present embodiment, this is the same with a configuration where the right eye image generating unit 32 is omitted instead. Also, in the same way as in a modification of the first embodiment, the direction from a right pixel to the pixel of interest may be used as the luminance gradient calculating direction to calculate luminance gradient indicating the rate of change thereof, and a configuration may be made where switching is enabled between a case where the position of a (virtual) illumination light source is at the upper left and a case of at the upper right.

### <2.3 Advantages of Second Embodiment>

As described above, the stereoscopic image generating device 30 according to the present embodiment can generate a stereoscopic image with a sufficient three-dimensional sensation from a single planar image, by computation even more simple than the first embodiment. Also, the positions of pixels are not changed, so even if left eye images and right eye images are displayed (typically alternately), these can be kept from appearing in double or not readily appearing in double. Further, due to this, the contents of the image, displayed typically on a frame-sequential 3D display device or the like, can be easily recognized by those not wearing the active shutter device 22, thus avoiding an unpleasant experience for such viewers.

### 3. Third Embodiment

### <3.1 Overall Configuration and Operation>

The stereoscopic image generating device 10 according to the present embodiment includes the same components as with the case of the first embodiment, and basically performs the same portions with regard to the point that stereoscopy is enabled by providing difference in luminesce distribution in accordance to pixel distances in a right eye image DR and left eye image DL. The right eye image generating unit 12 and left eye image generating unit 13 also provide difference in luminance distribution in the right eye image DR and left eye image DL based on high-frequency components of distance, besides distance.

In the same way as with the above Expression (1), if we say that the luminance value of the pixel of interest before correction at the right eye image generating unit 12 is DRp1, the luminance value following luminance correction is DR1, the distance value indicating the distance of the pixel of interest included in the distance signal Dd is Dd1, and further a value of high-frequency component of distance is Dh1, and constants are c1 and c2 (c1>0, c2>0), the luminance value DR1 after luminance correction in accordance with the luminance gradient LG can be obtained by the following Expression (3).

DR1=DRp1×(1+LG×c1/Dd1−Dh1×c2) (3)

Note that the above Expression (3) is only an example, and that the luminance value DR1 of the pixel of interest following luminance correction may be calculated from other predetermined mathematical expressions or based on a table defining correlations of values. Also, instead of this example of subtracting from the high-frequency component of distance value Dh1 a value obtained by multiplying the high-frequency component of distance Dh1 by the constant c2, an arrangement may be made where a suitable value determined as a function of the high-frequency component of distance value Dh1 is added, for example, so that the luminance value DR1 increases in a case where the distance of the pixel of interest is small in comparison to the distance of the surrounding pixels.

Now, the high-frequency component of distance can be easily obtained, specifically by applying a known hi-pass filter to each distance of pixels close to the pixel of interest, as illustrated in FIG. 5. Of course, high frequency components in change of distance may be calculated using other known techniques as well, as a matter of course.

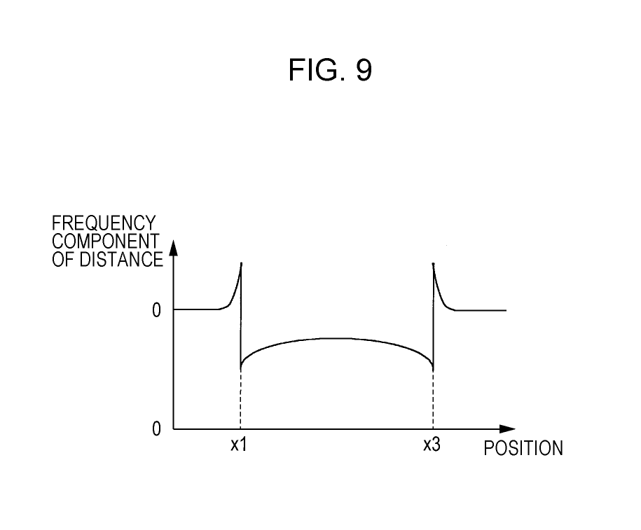

FIG. 9 is a diagram illustrating the relationship between positions of a series of pixels of interest illustrated in FIG. 2, and high-frequency component of the distance of the pixels of interest. As illustrated in FIG. 9, the high-frequency component of distance is great in the positive direction at portions where the distance to the pixel of interest is greater than the surroundings, i.e., at the recessed portion, and is small in the negative direction at portions where the distance to the pixel of interest is smaller than the surroundings, i.e., at the protruding portion (in the case of a negative value, the absolute value is great).

In this way, in a region where the high-frequency component of distance value Dh1 is smaller (typically negative), this indicates that the distance of the pixel of interest is smaller than the surrounding pixels, so further reducing the distance of the pixel of interest corresponding to this region can further intensity the three-dimensional sensation. The distance of surrounding pixels as to the distance of the pixel of interest is a relative relationship, so even if the distance of a pixel of interest is relatively great, the distance is set even smaller in the configuration of the present embodiment if the distance of this pixel of interest is smaller in comparison with the distance of the surrounding pixels. Accordingly, the three-dimensional sensation of (protruding images formed by) pixels at positions with great distance where three-dimensional sensation is hard to be obtained is emphasized, thereby obtaining an image where overall three-dimensional texture is clearly sensed.

Also, if we say that the luminance value of the pixel of interest before correction at the left eye image generating unit 13 is DLp1 and the luminance value following luminance correction is DL1, the luminance value DL1 after luminance correction in accordance with the luminance gradient LG can be obtained by the following Expression (2).

DL1=DLp1×(1−LG×c1/Dd1+Dh1×c2) (2)

Thus, in a case where the luminance gradient received from the luminance gradient calculating unit 11 is a positive value, the left eye image generating unit 13 reduces the luminance of the pixel of interest in accordance with the high frequency component of distance value Dh1, and in a case where the luminance gradient is a negative value, increases the luminance of the pixel of interest in accordance with the high frequency component of distance value Dh1. The left eye image generating unit 13 then outputs this as (the pixel value of) the left eye image DL.

The stereoscopic image signal generating unit 15 generates stereoscopic image signals Da alternatingly including the right eye image DR output from the right eye image generating unit 12 and the left eye image DL output from the left eye image generating unit 13 in predetermined time (typically, ½ frame period) increments. The stereoscopic image signals Da are played on the 3D display device 20 as described earlier, and recognized as three-dimensional images by the user U (viewed stereoscopically).

### <3.2 Advantages of Third Embodiment>

As described above, the stereoscopic image generating device 10 according to the present embodiment can obtain an image where overall three-dimensional texture is clearly sensed in accordance with distance from a single planar image, by just simple computation of calculating luminance gradient between adjacent pixels and calculating high-frequency components of distance. Also, advantages the same as with the first embodiment can be obtained.

### 4. Fourth Embodiment

### <4.1 Overall Configuration and Operation>

The overall configuration of the stereoscopic image generating device according to the present embodiment is the same as with the configuration of the stereoscopic image generating device according to the first embodiment illustrated in FIG. 1, and the operations are the same other than the method of calculating the amount of increase and the amount of decrease of luminance correction at the right eye image generating unit 12 and left eye image generating unit 13 being different. Accordingly, these are denoted with the same reference numerals as those of the first embodiment, and description of the components will be omitted except for the aforementioned calculation method.

The present embodiment also performs detection of edges of three-dimensional objects indicated by the image where the distance between pixels rapidly changes (hereinafter referred to as “edge detection”), so as to stop luminance correction operation (i.e., an operation to set the amount of correction to zero). Hereinafter, luminance correction operations by the right eye image generating unit 12 and left eye image generating unit 13 will be described.

### <4.2 Calculation Operation of Correction Amount for Luminance Correction>

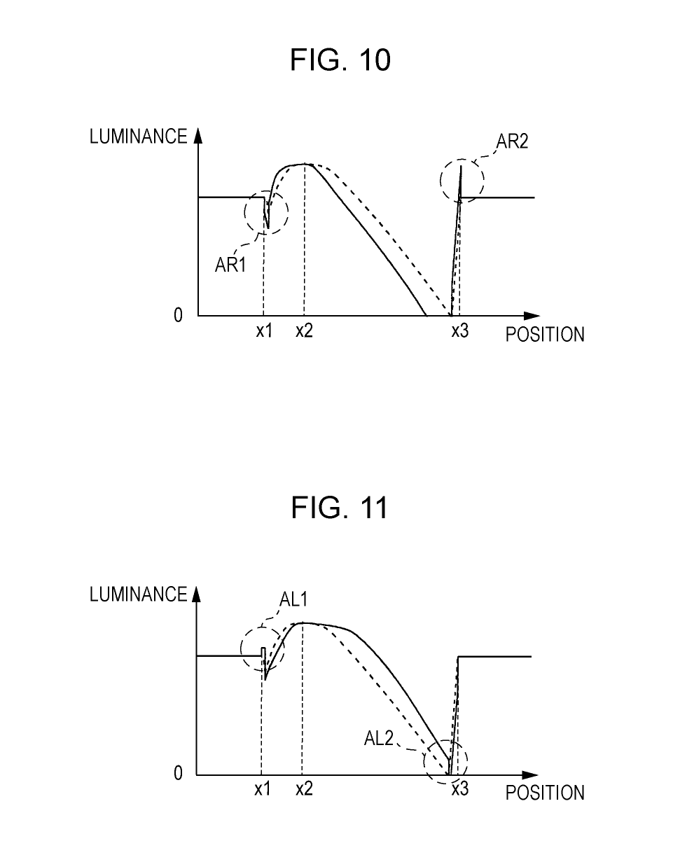

The right eye image generating unit 12 and left eye image generating unit 13 according to the present embodiment perform operations to set the correction amount to zero and stop (omit) luminance correction in a case where the absolute value of a derivative value exceeds an edge detection threshold Eth. This derivative value is obtained by differentiation of values indicating distance of pixels included in the distance signals Dd (specifically, by applying a known differentiation filter). The reason this operation to stop luminance correction is to avoid the following problem. If the luminance correction operation is continued without change, the luminance change will become abnormally great around the edges, and the stereoscopic image to be generated will exhibit abnormalities. This problem will be described with reference to FIG. 10 and FIG. 11.

FIG. 10 is a diagram illustrating the relation between luminance and the position of a pixel group corresponding to a right eye image obtained by correcting the luminance of the series of pixels of interest illustrated in FIG. 2, in a case where the aforementioned stopping operation based on edge detection is not performed. Also, FIG. 11 is a diagram illustrating the relation between luminance and the position of a pixel group corresponding to a left eye image obtained by similar luminance correction. The dotted lines in the drawings are the series of pixels of interest illustrated in FIG. 2. The change in luminance is abnormally great in areas AR1 and AR2 in FIG. 10, due to luminance correction being continued without stopping operations. Such abnormalities occur due to the following reason. That is to say, it is known that luminance gradient becomes very great around edges. If the luminance gradient is very great, the correction amount also becomes great and the luminance value following correction changes greatly (strictly speaking, within a range of not exceeding the maximum value or falling below the minimum value), which can be seen from the above Expression (1).

Also, abnormality in change of luminance also occurs in the same way in the left eye image, and moreover is change in the opposite direction, as illustrated in FIG. 11. FIG. 11 is a diagram illustrating the relation between luminance and the position of a pixel group corresponding to a left eye image obtained by correcting the luminance of the series of pixels of interest illustrated in FIG. 2, in a case where the aforementioned stopping operation based on edge detection is not performed. The change in luminance is abnormally great in areas AL1 and AL2 in FIG. 11, due to luminance correction being continued without stopping operations. Further, comparison of FIG. 10 and FIG. 11 will reveal that the direction of change in luminesce at the abnormal portions is in opposite directions, so that the difference in luminance spreads to the left and right. Accordingly, when the user U views the two images as a stereoscopic image using the active shutter device 22, the difference in luminance is very conspicuous at the image portions corresponding to the above regions, and consequently abnormality of the image becomes more conspicuous.

Accordingly, in a case where the change in luminance is very great as described above, specifically in a case where the absolute value of a derivative value Dd1d of a value indicating distance of a pixel of interest included in the distance signal Dd (a rate of change in a predetermined direction), which is |Dd1d|, exceeds the edge detection threshold Eth, the right eye image generating unit 12 performs an operation to stop luminance correction (sets the correction amount to zero). Accordingly, regardless of the results of luminance correction based on the above Expression (1), DR1=DRp1 if |Dd1d|>Eth. In the same way, the left eye image generating unit 13 sets DL1=DLp1 if |Dd1d|>Eth. Setting the correction amount to zero at the edge portion by stopping luminance correction enables abnormal change due to luminance correction such as illustrated in FIG. 10 and FIG. 11 to be prevented, and thus occurrence of abnormalities in the image can be suppressed.

Also, the configuration according to the present embodiment enables great change in luminance near edges to be avoided, and also difference (in luminance) between the right eye image and left eye image near edges to be suppressed or resolved. Accordingly, the user seeing the images in double when viewing the stereoscopic image can be prevented in a sure manner. That is to say, when around the edges appears in double the overall image often appears in double, so suppressing or resolving difference in luminance (in the left and right images) near the edges enables an image which less readily appears in double or does not appear in double to be generated.

From the above, it is sufficient in the present embodiment to be able to detect edges, which may be performed based on a known edge detecting technique such as a technique according to pattern recognition, instead of performing edge detection based on differential values of distances corresponding to pixels as described above. Also, image edges corresponding to the edge detection may be performed based on known techniques for detecting image edges. For example, an image edge detection technique using the absolute value of luminance gradient LG, which is |LG|, is suitable here since luminance gradient is necessary to calculate the amount of correction and this can be used.

Of course, portions with great change in image luminance are not always edges of three-dimensional objects indicated by the image, so there are cases where erroneous detection occurs in image edge detection. However, pixels with great change in distance are almost sure to be edges of three-dimensional objects, so it can be said to be most suitable to use distance for edge detection (in cases where the amount of distance data and precision is sufficient).

### <4.3 Advantages of Fourth Embodiment>

As described above, the stereoscopic image generating device 10 according to the present embodiment exhibits advantages the same as the first embodiment, and also can prevent abnormalities from occurring in the stereoscopic image by setting the amount of correction to zero around where luminance change near edges becomes abnormally great, thereby stopping luminance correction.

Also, the configuration of the present embodiment may be applied to configurations of other embodiments (and their modifications). Accordingly, advantages unique to the present embodiment can be further exhibited in addition to the above-described advantages.

### <4.4 Modification of Fourth Embodiment>

Using distance for edge detection as with the fourth embodiment described above is suitable in a case where the amount and precision of distance data is sufficient. Accordingly, if such data is insufficient, in a case where one pixel block is made up of a great number of pixels, such as a hundred or more for example, in a configuration where one distance is determined corresponding to one pixel block made up of multiple nearby pixels, such as illustrated in FIG. 5, for example, there will be shift or error between the actual edge positions (coordinates of pixels corresponding to edge) and edge positions in increments of pixel blocks that are detected.

Accordingly, edge detection is performed in increments of pixel blocks based on derivative values of distance such as with the fourth embodiment described above. Also, image edge detection using the absolute value of the luminance gradient LG, which is |LG|, (or known image edge detection using differentiating filters or the like,) is performed as well. Operations are performed to set the correction amount to zero and stop (omit) luminance correction regarding only luminance value of pixels detected as the edge in both.

Thus, even in a case where the amount and precision of distance data is not sufficient, edge detection can be performed in increments of pixels of the image rather than in pixel block increments. Accordingly, edge positions are more precise, and erroneous detection occurring in a configuration which performs image edge detection can be resolved or suppressed by edge detection based on distance.

Note that it is sufficient for edge detection using derivative values of distance and luminance gradient (derivative values of luminance) together as described above, so a configuration may be made where computation is performed first to calculate derivative values of distance, for example, and image edge detection is performed based on luminance gradient only with regard to multiple pixels corresponding to a pixel block detected as an edge. Thus, the amount of computation can be reduced.

### 5. Fifth Embodiment

### <5.1 Overall Configuration and Operation>

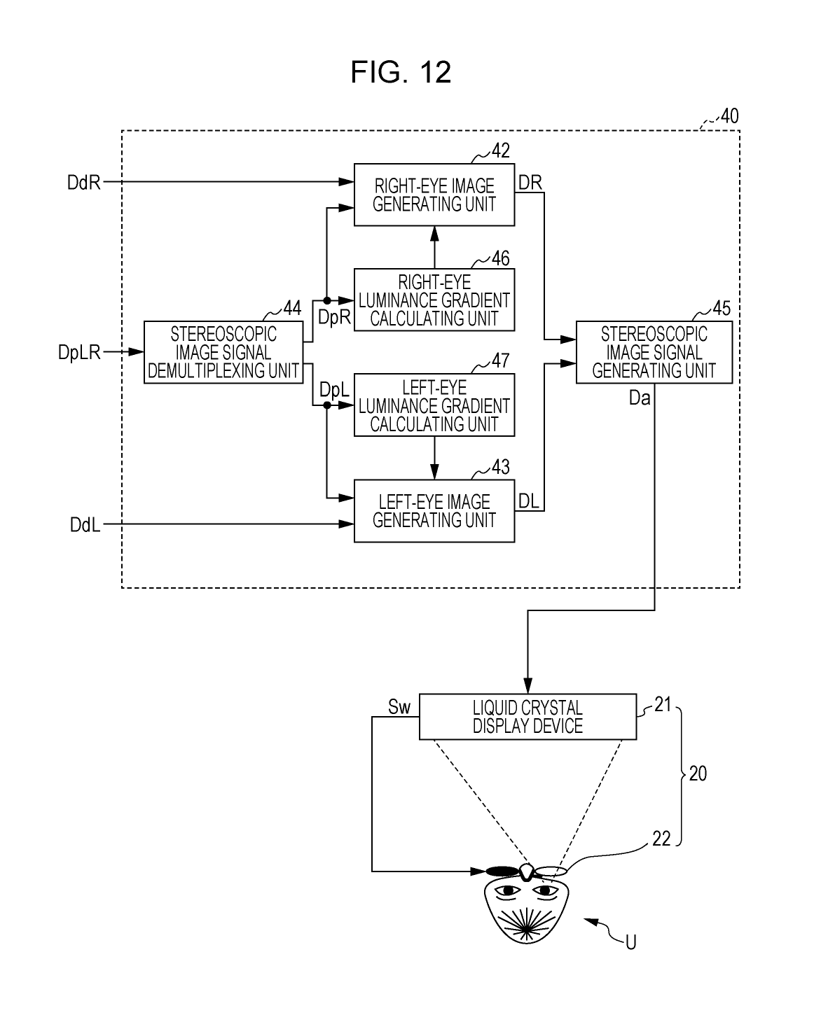

FIG. 12 is a block diagram illustrating the configuration of a stereoscopic image generating device according to a fifth embodiment of the present invention. As illustrated in FIG. 12, the stereoscopic image generating device 40 includes a stereoscopic image signal demultiplexing unit 44 which receives stereoscopic image signals DpLR including a stereoscopic image from an external (unshown 3D graphics device), and demultiplexes into an external right eye image DpR and external left eye image DpL which are output. The stereoscopic image generating device 40 also includes a right eye luminance gradient calculating unit 46 which receives the external right eye image DpR from this stereoscopic image signal demultiplexing unit 44 and calculates right eye luminance gradient, and a right eye image generating unit 42 which generates a right eye image DR based on the external right eye image DpR, the right eye luminance gradient, and external right eye distance signals DdR. The stereoscopic image generating device 40 also includes a left eye luminance gradient calculating unit 47 which receives the external left eye image DpL from the stereoscopic image signal demultiplexing unit 44 and calculates left eye luminance gradient, and a left eye image generating unit 43 which generates a left eye image DL based on the external left eye image DpL, the left eye luminance gradient, and external left eye distance signal DdL. The stereoscopic image generating device 40 also includes a stereoscopic image signal generating unit 45 which generates stereoscopic image signals Da from a right eye image DR and left eye image DL.

Note that the 3D display device 20 illustrated in FIG. 12 is of the same configuration as that of the first embodiment illustrated in FIG. 1, so description will be omitted. Also, the stereoscopic image signals DpLR may be the same as the stereoscopic image signals Da according to the first embodiment, or may be stereoscopic image signals which are the same as with the conventional art, including an external left eye image DpL and external right eye image DpR where the positions of corresponding pixels are differ between the left and right.

Further, the stereoscopic image signals DpLR may be signals employing the frame sequential format the same as with the stereoscopic image signals Da provided to the 3D display device 20, or may be of the so-called side-by-side format which includes the external right eye image DpR at the right half portion and the external left eye image DpL at the left half portion of a (single) image provided as a single frame, or may be of the so-called top-and-bottom format where these are included in the top half portion and bottom half portion, or the like.

Accordingly, the present embodiment does not externally receive a planar image but rather receives a stereoscopic image, so a stereoscopic image can be generated which has sufficient three-dimensional sensation, even if no luminance correction is performed at all. However, externally-obtained stereoscopic images may have too strong a three-dimensional sensation (sensation of distance is too close) or too weak a three-dimensional sensation (sensation of distance is too far), in some cases. For example, in a case of shooting a person relatively far away using a stereo camera device or stereo video device or the like which can acquire stereoscopic images, the sensation of distance (three-dimensional sensation) that the person is closer than the background can be correctly obtained, but there are cases where the person appears to be flat (like a picture of a person drawn on a plate, for example), and three-dimensional sensation of a rounded person cannot be obtained. On the other hand, if the three-dimensional sensation is too strong, there may be problems of eye fatigue and so forth. In such cases, the stereoscopic image generating device 40 according to the present embodiment can suitably correct the three-dimensional sensation (sensation of distance) in external stereoscopic images. The luminance correction operations thereof will be described below.

### <5.2 Luminance Correction Operation of Stereoscopic Image Generating Device>

First, in the same way as with the first embodiment, the right eye luminance gradient calculating unit 46 includes a left pixel luminance storage unit which stores one pixel worth of (luminance value of) external right eye image DpR, and calculates a value obtained by subtracting the luminance value stored in the left pixel luminance storage unit from the luminance value of the received pixel of interest, as the luminance gradient. The left eye luminance gradient calculating unit 47 calculates the left eye luminance gradient in the same way.

Next, in a case where strengthening the three-dimensional sensation is desired, due to a reason such as three-dimensional sensation of roundness of a person far away not being obtained as described above, the right eye image generating unit 42 performs luminance correction to increase the luminance of the pixel of interest in the external right eye image DpR in accordance with the distance thereof if the right eye luminance gradient is a positive value. The right eye image generating unit 42 performs luminance correction to decrease the luminance of the pixel of interest in accordance with the distance thereof if the right eye luminance gradient is a negative value. The right eye image generating unit 42 outputs this as (the pixel value of) the right eye image DR. Also, the left eye image generating unit 43 performs luminance correction to decrease the luminance of the pixel of interest in the external left eye image DpL in accordance with the distance thereof if the left eye luminance gradient is a positive value. The left eye image generating unit 43 performs luminance correction to increase the luminance of the pixel of interest in accordance with the distance thereof if the left eye luminance gradient is a negative value. The left eye image generating unit 43 outputs this as (the pixel value of) the left eye image DL.

Thus, luminance correction is performed such that the luminance distribution of the external right eye image DpR is shifted further to the right, and the external left eye image DpL further to the left, so a luminance distribution state the same as with the first embodiment is realized in to the stereoscopic image. Accordingly, the three-dimensional sensation (sensation of distance) is further strengthened from the three-dimensional sensation to be realized by the stereoscopic image signals DpLR including the external stereoscopic image.

Also, in a case where weakening (cancelling out) of the three-dimensional sensation is desired due to a reason such as reducing eye fatigue, the luminance correction operations of the left eye image generating unit 43 and the right eye image generating unit 42 can be reversed. Thus, luminance correction is performed such that the luminance distribution of the external right eye image DpR is shifted to the left, and the external left eye image DpL to the right, so a luminance distribution state the opposite (direction) of the first embodiment is realized in to the stereoscopic image. Accordingly, the three-dimensional sensation (sensation of distance) is weakened from the three-dimensional sensation to be realized by the stereoscopic image signals DpLR including the external stereoscopic image.

Thus, the left eye image generating unit 43 and right eye image generating unit 42 perform luminance correction operations with mutually opposite increasing and decreasing in the same way as with the case of the first embodiment. However, a configuration may be made instead of the above configuration, where, the right eye luminance gradient calculating unit 46 and right eye image generating unit 42 are omitted and luminance correction is not performed for the right eye image, or the left eye luminance gradient calculating unit 47 and left eye image generating unit 43 are omitted and luminance correction is not performed for the left eye image, in the same way as with the second embodiment.

Also, in the same way as in a modification of the first embodiment, the direction from a right pixel to the pixel of interest may be used as the luminance gradient calculating direction for the right eye luminance gradient calculating unit 46 and left eye luminance gradient calculating unit 47 to calculate luminance gradient indicating the rate of change thereof, and a configuration may be made where switching is enabled between a case where the position of a (virtual) illumination light source is at the upper left and a case of at the upper right.

### <5.3 Advantages of Fifth Embodiment>

As described above, the stereoscopic image generating device 40 according to the present embodiment can generate a stereoscopic image where the three-dimensional sensation is further enhanced from (a right eye image and left eye image realizing) a stereoscopic image, or a stereoscopic image where the three-dimensional sensation weakened instead. Also, the degree of strengthening or the degree of weakening the three-dimensional sensation can be optionally set, since the three-dimensional sensation can be strengthened by increasing the absolute value of the amount of correction, and the three-dimensional sensation can be weakened by decreasing the absolute value of the amount of correction. Further, in (a configuration using stereoscopic images) the same way as with the case of the first embodiment, positions of pixels are not changed, so even if left eye images and right eye images are displayed (typically alternately), these can be kept from appearing in double or not readily appearing in double.

### INDUSTRIAL APPLICABILITY

The present invention is applied to a display device enabling stereoscopy for example, and relates to a method for generating a stereoscopic image including a left eye image and a right eye image enabling stereoscopy, a generating device thereof, and a display device such as a television device or the like including the same.

### REFERENCE SIGNS LIST

10, 30, 40 stereoscopic image generating device
11, 31 luminance gradient calculating unit
12, 32, 42 right eye image generating unit
13, 43 left eye image generating unit
15, 35, 45 stereoscopic image signal generating unit
20 3D display device
21 liquid crystal display device
22 active shutter device
44 stereoscopic image signal demultiplexing unit
46 right eye luminance gradient calculating unit
47 left eye luminance gradient calculating unit
U user

1. A stereoscopic image generating method to generate an image enabling stereoscopy, based on one or more input images representing a three-dimensional object, and distance to the three-dimensional object corresponding to pixels of the input image, the method comprising:
a luminance gradient calculating step to, when having set a starting point and ending point which determine a luminance gradient calculation direction corresponding to a direction from one eye to the other eye of a user who performs stereoscopy, such that the ending point is a pixel of interest included in the input image and the starting point is a pixel adjacent to or near the pixel of interest, calculate a luminance gradient from the pixel serving as the starting point to the pixel of interest;
a luminance-corrected image generating step to generate an image where the input image has been subjected one or two luminance corrections, by performing at least one of a first correction in which a correction amount of the same sign as that of the positive or negative luminance gradient is applied to the luminance of the pixel of interest, and a second correction in which a correction amount of the opposite sign as that of the positive or negative luminance gradient is applied to the luminance of the pixel of interest; and
a correction amount calculating step to set the correction amount such that the greater an absolute value of the luminance gradient is, and the smaller the distance corresponding to the pixel of interest is, the greater an absolute value of the correction amount is;
wherein, in the luminance-corrected image generating step, either the luminance-corrected image obtained by the first correction, or in a case where this image is not generated, the input image, is output as an image to be provided to the other eye of the user, and either the luminance-corrected image obtained by the second correction, or in a case where this image is not generated, the input image, is output as an image to be provided to the one eye of the user.

2. The stereoscopic image generating method according to claim 1, wherein in the correction amount calculating step, in a case where an absolute value of a derivative value, indicating a rate of change of distance corresponding to the pixel of interest in a predetermined direction, is equal to or greater than a predetermined threshold value, determination is made that the pixel of interest is included in an edge portion of the input image, and the correction amount is set to zero.

3. The stereoscopic image generating method according to claim 1, wherein in the correction amount calculating step, the correction amount is determined such that the smaller a high-frequency component in change of corresponding distance in a predetermined direction is, the greater an absolute value of the correction amount of the pixel of interest is.

4. A stereoscopic image generating device to generate an image enabling stereoscopy, based on one or more input images representing a three-dimensional object, and distance to the three-dimensional object corresponding to pixels of the input image, comprises:
a luminance gradient calculating unit configured to, when having set a starting point and ending point which determine a luminance gradient calculation direction corresponding to a direction from one eye to the other eye of a user who performs stereoscopy, such that the ending point is a pixel of interest included in the input image and the starting point is a pixel adjacent to or near the pixel of interest, calculate a luminance gradient from the pixel serving as the starting point to the pixel of interest;
a luminance-corrected image generating unit configured to generate an image where the input image has been subjected one or two luminance corrections, by performing at least one of a first correction in which a correction amount of the same sign as that of the positive or negative luminance gradient is applied to the luminance of the pixel of interest, and a second correction in which a correction amount of the opposite sign as that of the positive or negative luminance gradient is applied to the luminance of the pixel of interest; and
a correction amount calculating unit configured to set the correction amount such that the greater an absolute value of the luminance gradient is, and the smaller the distance corresponding to the pixel of interest is, the greater an absolute value of the correction amount is;
wherein, the luminance-corrected image generating unit outputs either the luminance-corrected image obtained by the first correction, or in a case where this image is not generated, the input image, as an image to be provided to the other eye of the user, and outputs either the luminance-corrected image obtained by the second correction, or in a case where this image is not generated, the input image, as an image to be provided to the one eye of the user.

5. The stereoscopic image generating device according to claim 4, wherein the luminance-corrected image generating unit generates one luminance-corrected image by performing only one of the first and second correction.

6. The stereoscopic image generating device according to claim 4, wherein in a case where an absolute value of a derivative value, indicating a rate of change of distance corresponding to the pixel of interest in a predetermined direction, is equal to or greater than a predetermined threshold value, the correction amount calculating unit determines that the pixel of interest is included in an edge portion of the input image, and sets the correction amount to zero.

7. The stereoscopic image generating device according to claim 4, wherein in a case where an absolute value of a derivative value, indicating a rate of change of distance corresponding to the pixel of interest in a predetermined direction, is equal to or greater than a predetermined threshold value, and the absolute value of the luminance gradient is equal to or greater than a predetermined threshold value, the correction amount calculating unit determines that the pixel of interest is included in an edge portion of the input image, and sets the correction amount to zero.

8. The stereoscopic image generating device according to claim 4, wherein the correction amount calculating unit determines the correction amount such that the smaller a high-frequency component in change of corresponding distance in a predetermined direction is, the greater an absolute value of the correction amount of the pixel of interest is.

9. The stereoscopic image generating device according to claim 4, wherein the correction amount calculating unit restricts the absolute value of the correction amount to a predetermined value or lower.

10. The stereoscopic image generating device according to claim 4, wherein the input image is an image enabling stereoscopy, and is made up of a first input image to be provided to the other eye of the user, and a second input image to be provided to the one eye of the user;
wherein, in order to further strengthen the three-dimensional sensation obtained when performing stereoscopy of the input image, the luminance-corrected image generating unit outputs either the luminance-corrected image obtained by the first correction having been performed on the first input image, or in a case where this image is not generated, the first input image, as an image to be provided to the other eye of the user, and outputs either the luminance-corrected image obtained by the second correction having been performed on the second input image, or in a case where this image is not generated, the second input image, as an image to be provided to the one eye of the user.

11. The stereoscopic image generating device according to claim 10, wherein, in order to weaken the three-dimensional sensation obtained when performing stereoscopy of the input image, the luminance-corrected image generating unit outputs either the luminance-corrected image obtained by the second correction having been performed on the first input image, or in a case where this image is not generated, the first input image, as an image to be provided to the other eye of the user, and outputs either the luminance-corrected image obtained by the first correction having been performed on the second input image, or in a case where this image is not generated, the second input image, as an image to be provided to the one eye of the user.

12. A stereoscopic image display device comprising:
the stereoscopic image generating device according to claim 4;
a display unit configured to alternately display an image to be provided to one eye of the user and an image to be provided to the other eye; and
a shutter unit configured to, in a case where the image to be provided to the one eye is displayed on the display unit, perform shielding such that the image is not visible to the other eye of the user, and in a case where the image to be provided to the other eye is displayed, perform shielding such that the image is not visible to the one eye of the user.
